(19) United States
(12) Patent Application Publication
(10) Pub. No.: US 2002/0175995 A1
(43) Pub. Date: Nov. 28, 2002

(54) Video surveillance system

(76) Inventor: Marc Sleeckx, Acworth, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 09/866,390

(22) Filed: May 26, 2001

(51) Int. Cl. H04N 7/18

(52) U.S. Cl. 348/143

(57) ABSTRACT

A video surveillance system which includes at least one field recording site and at least one remote viewing site linked by a communication channel of the internet. The field site locates a video surveillance recorder which archives a compressed digital video signal from a video source to a digital memory. Similarly, data associated with the video signal is archived to a digital memory. The archived video signal is stored in file segments associated with the times they are recorded. The system further provides a compressed real time video signal. The video surveillance system also includes a server interface to the internet whereby the field site may be controlled to provide the video and data information to a user at the remote site. User commands may be communicated from the remote site to the field site to transfer either the real time video signal, the archived video signal or the archived data signal. The selected signal is then displayed on a video monitor of the remote viewing site. Specific times of the archived video signal or the archived data signal may be viewed by selecting from a list of files archived on the digital memory. The surveillance system may have more than one field site recorder and/or more than one remote viewing site.

### BACKGROUND OF THE INVENTION

1. Field of the Invention

The present invention generally relates to video surveillance systems, such as CCTV security systems and the like, and more particularly to video surveillance systems which can be remotely accessed for either real time video information, archived video information or data information.

2. Description of Background Art

Video surveillance systems have been used in a number of commercial establishments to provide visual records of in-store events. Typically, one or more video cameras are used to generate video signals from the areas which are surveilled. These video signals are often displayed in real time on an video display for monitoring in store activity by security personnel or to notify persons that a area is under video surveillance. These closed circuit television (CCTV) systems also commonly record or archive some or all of the video signals, usually with a video cassette recorder (VCR) on a standard video cassette tape which can then be replayed on that or a different VCR. Such recordings produce a visual archive of the vents surveilled and may include audio signals. These recordings may be used later to provide corroboration of events noted by the real time viewing of security personnel or reviewed to determine if an event of interest occurred when there is no real time monitoring.

Many CCTV systems use multiplexers to combine video signals from several cameras to reduce the number of video recorders and amount of video tape needed for a particular surveilled location. A typical multiplexer used is a quad multiplexer which combines four video signals into a single video signal. While a 4:1 reduction is obtained in the amount of cassettes used for a particular location, the size of each video signal recorded is also reduced accordingly.

While the VCR/cassette tape based surveillance system has gained wide popularity, it has several drawbacks. Such systems are relatively expensive and labor intensive to produce and maintain a reasonably sized archive. A VCR must be used for each video signal stored at a particular and individual cassettes must be periodically inserted and retrieved when full. The cassettes must then be indexed with the date and time they were recorded and the location of any particular events noted in real time on the tape. The tapes must then be stored on location or transported to a central storage area, or archived until they are needed or are reviewed. The cost of the VCRs and cassettes, and the expense and time of changing, indexing, transporting, storing and reviewing the cassettes is considerable.

These problems are compounded for commercial establishments which may have several hundreds of stores located remotely from one another and from a central review site. Finding a particular event in a cassette based surveillance system for such establishments can be difficult. The identification and location of cassettes for a specific site must first be made. The index for these cassettes is then reviewed to determine which cassette contains the particular time for the event. Only then can the event cassette be played back and the event reviewed to ascertain its details.

Another issue with a VCR based surveillance system is that it does not provide for remote viewing of the real time video information. It is much too costly to maintain around the clock security personnel at most surveilled sites, and for many small sites there may not be any on site security personnel. Therefore, much of the recorded video of such systems is not viewed in real time. Managers when they are off site have many valid reasons to want to view the workings of a store in real time. If a manager is responsible for several stores, a remote real time view is a helpful way to visit all of the stores even though he can not physically be at each one. Further, the remote viewing of real time video information from a surveilled site is a method of verifying the surveillance cameras and other equipment of the system are working. Moreover, the ability to remotely view the surveilled site in real time will reduce the number of false security alarms which are generated to police. When a forced entry alarm for a door or a window, or an alarm from a pressure or motion detector, generates an intruder alert, a remote real time view of the area would verify whether the alarm was actual event needing immediate intervention or whether it was a false alarm without having to send a person to the site.

Additionally, when viewing either real time either information or archived video information for a surveillance system there are situations where it would be helpful to concurrently review data associated with the event shown in the video information. Data which may be related to the surveilled video information and useful in resolving an event or transaction could include point of sale data from a cash register, credit card scanner, or bar code scanner; or alarm system status data, status information from the surveillance system, etc. It is very difficult to match associated data with a visual event recorded on a video cassette in present systems and is more costly to do so remotely.

Therefore, it would be advantageous to provide a video surveillance system which archived video information in a low-cost and low-maintenance manner. It would be more advantageous to provide a low-cost and low-maintenance archive of video information that could be randomly accessed to find a particular event easily.

It would also be advantageous to provide a video surveillance system where real time video data information could be easily transported for viewing to a site remote from where it was being taken. Such a surveillance system would be more advantageous if the real time video information could be easily and selectively transported from a multiplicity of sites for remote viewing.

Additionally, it would be advantageous to provide a video surveillance system in which archived video information could be easily transported for viewing to a site remote from where it was recorded. Such a surveillance system would be more advantageous if the archived video information could be easily and selectively transported from a multiplicity of sites for remote viewing.

Moreover, it would be advantageous to provide a video surveillance system where data associated with real time or archived video information could be easily transported for viewing to a site remote from where it was recorded. Such a surveillance system would be more advantageous if the associated data could be easily and selectively transported from a multiplicity of sites for remote viewing.

A video surveillance system would be particularly advantageous if real time video information, archived video information and/or data associated with such video information could be easily and selectively transported for viewing to a site remote from where it was recorded. Such a surveillance system would be more advantageous if the real time video information, archived video information and/or associated data could be easily and selectively transported from a multiplicity of sites for remote viewing.

### SUMMARY OF THE INVENTION

The invention provides an improved video surveillance system including a remote video recorder for a particular field location which is capable of capturing video information in a digital archive which can be randomly accessed. The digital archiving of the video information allows events which are stored to easily and quickly retrieved. The remote video recorder includes a general purpose digital processor and preferably, the digital archive is implemented in the nonvolatile portion of memory the computer, such as a hard disk drive.

In the illustrated embodiment, the video recorder uses a video capture apparatus to digitize one or more analog video signals from video sources, such as cameras, which are used for surveillance, and form a combined digital input video information stream. Alternatively, the video capture apparatus could receive inputs from one or more digital cameras and convert them into a combined digital stream.

The input video stream is manipulated by a video input processor, preferably in the form of a video processing program which is adapted to receive a video information signal containing the multiple sources and compress the signal for storage. The compressed video information signal is then stored to the digital archive, preferably the hard disk drive of a general purpose digital computer.

This type of nonvolatile random access memory provides sufficient and reliable storage at a reasonable cost for large amounts of data, preferably at least 30 gigabytes or more. The hard disk of a general purpose digital computer is able to be randomly accessed for files at any time Alternatively, the digital archive can be any digital memory which can be randomly accessed and is sufficient to store the amount of data desired at the particular field location.

According to one aspect of the invention, the video input signal may also be archived to a second back up memory, preferably a second hard disk drive of at least 30 gigabytes or more. Alternatively, the second back up memory can be any digital memory which can be randomly accessed and is sufficient to store the amount of data desired at the particular field location.

Another feature of the invention provides for the interface of the processed input video signal, in either its real time version or its archived version, to an output streaming process which transfers the processed video signal over a communications link to a site remote from the field location. Preferably the output streaming process is in the form of a video processing program which is adapted to receive the processed video input signal and transmit it over a communications link.

The operating system of the digital processor is preferably a modified kernel of a LINUX operating system which utilizes a memory map for the input and output addresses of the digital archive memory and an input pipe to the output streaming process.

At individual field sites, the communications link in the preferred embodiment is an internet web site which can accessed by an interactive control program of a remote digital processor through a standard interface including an internet search engine and internet service provider. The control program provides a graphical interface by which a user selects commands to control the digital processor of the field site including the output streaming process. In this manner, the stored or real time video signals may be conveniently accessed by the remote digital processor and control program from anywhere there is internet service which is now virtually worldwide. The linking of the field site to the remote site through the internet also provides a cost effective way of communicating the information as standard interfaces may be used and the network communications equipment used is available through an internet service provider (ISP).

In one preferred embodiment, the user may select either the archived digital video files or the real time processed video input signal to be streamed to the remote site by clicking on an associated icon on the graphical interface. The selected video information signal is communicated over the communications link and is received by a remote streaming process and decompressed. The selected video signal is then displayed on the video monitor of the remote digital processor to provide for the remote viewing of the images from the field site. If the user selects the archived video signals from the field site, a table of the video files which are available is obtained from the field site and displayed on the video monitor of the remote digital processor. Preferably, this display is in the form of graphic icons representing a calendar divided into months and days indicating a date and a day clock divided into video file length segments, for example in hours. The user then selects a video file by clicking on the date from the calendar icon and a video file segment from the clock icon. This information is communicated as a command to the field site to stream the digital video file identified as to a particular time to the remote site.

Still another aspect of the invention includes the remote viewing of either archived video or real time video from a plurality of field sites. The user may select form a list of available field sites. The field sites are defined and stored on the remote terminal.

Optionally, the site terminal may be connected to co-located data sources which are associated with the video. Preferably these are point of sale terminals, such as cash registers, automated customer terminals or the like, each of which is adapted to send point of sale data to the site terminal for archiving.

These and other objects, aspects and features of the invention will be more clearly understood and better described when the following detailed description is read in conjunction with the attached drawings, wherein similar elements throughout the views have the same reference numerals, and wherein:

### BRIEF DESCRIPTION OF THE DRAWINGS

FIG. 1 is a system block diagram of one embodiment of a surveillance system constructed in accordance with the invention;

FIG. 2 is an electrical schematic block diagram of the digital video recorder or site terminal illustrated in FIG. 1;

FIG. 3 is an electrical schematic block diagram of the remote viewing terminal illustrated in FIG. 1;

FIG. 4 is a detailed system process diagram of the digital video recorder or site terminal illustrated in FIG. 2;

FIG. 5 is a detailed system process diagram of the remote viewing terminal illustrated in FIG. 1;

FIG. 6 is a detailed system process diagram of the interactive graphical interface of the remote viewing terminal illustrated in FIG. 1;

FIG. 7 is a pictorial representation of an initial viewing widow of the interactive graphical interface;

FIG. 8 is a pictorial representation of an the select video recorder display widow of the interactive graphical interface during selection of an archived video file;

FIG. 9 is a pictorial representation of an the archived video display widow of the interactive graphical interface during selection of an archived video file;

FIG. 10 is a pictorial representation of the real time video information display widow of the interactive graphical interface;

FIG. 11 is a pictorial representation of an the archived video display widow of the interactive graphical interface during display of archived video information; and

FIG. 12 is a pictorial representation of the archived data display widow of the interactive graphical interface during display of archived data information.

### DETAILED DESCRIPTION OF A PREFERRED EMBODIMENT

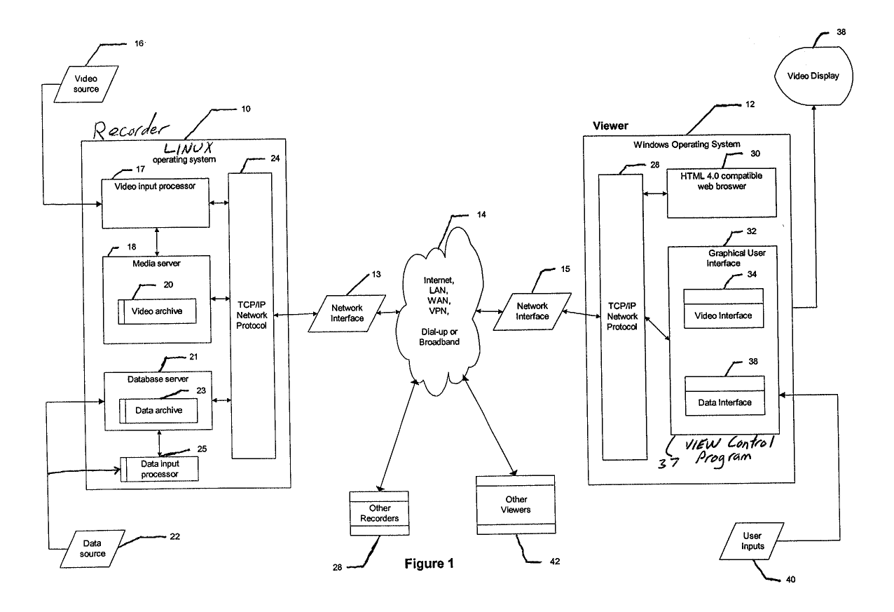

FIG. 1 illustrates a system block diagram of one embodiment of a surveillance system constructed in accordance with the invention. The system includes a digital video recorder or site terminal 10 located a site that is to be surveilled and a viewer or remote terminal 12. The site terminal 10 and the remote terminal 12 communicate over a communications link 14 to transfer either a real time video information signal or an archived video information signal from the site terminal 10 to the remote terminal 12. Optionally, a archived data information signal can additionally be communicated to the remote terminal 12 over the communications link 14. The viewer terminal 12 can request the type of information stream that a user desires to view and the site terminal 10 responds to the request to provide the type of information requested.

The communications link 14 of the surveillance system transfers information in TCP/IP format from network interface 13 across the link 14 and to network interface 15 and vice versa. The information is formatted/deformatted by a TCP/IP network protocol interface 24 at the recorder 10 and a similar TCP/IP network protocol interface 28 at the viewer 12. The protocol used is conventionally termed packet switched data and the communications link commonly referred to as the internet. While the preferred implementation of the communication link 14 will be described as the internet. The communications link 14 could also comprise a corporate LAN, WAN, VPN, the telephone system, wireless links or the like.

Optionally, the surveillance system may have a plurality of site terminals 10 (other recorders 28), each of which can interrogated for information by the viewer terminal 12. Because of the flexibility of the internet connection, a remote terminal 12 may communicate with any one of a number of recorders 10 by knowing its IP addresses. Additionally, because the TCP/IP allows multiple access, the remote terminal may interrogate more than one recorder 10 at a time. Optionally, the surveillance system may have a plurality of remote terminals 12 (other viewers 42) which can interrogate any of the multiple number of recorders 10. Any additional remote terminals 12 can easily be connected to the network and given the IP address of any site terminal to which they are to communicate. Additionally, because the TCP/IP allows multiple access, more than one remote terminal 12 can interrogate a recorder 10 at one time.

The site terminal 10 comprises a video surveillance recorder which receives video information from a video source 16 and encodes the video information into a digital information stream with a video input processor 16. The information stream is a real time video stream which can be directly coupled to an output processor, implemented as a video server 18, or stored on a digital video archive 20. Similarly, an input data processor 25 is adapted to receive information from a data source 22 and store it on the digital data archive 23. The input data processor 25 is coupled to an output data processor, implemented as a database server 21. The output processors 18, 21 are capable of accessing and reading the stored video or data files in the video and data archives 20 and 23. In response to a request from the remote terminal 12 through interface 24, the output processors 16, 21 will cause an information stream to be transmitted across the communications link 14. The information stream can be the real time video stream, the archived video stream, the real time data stream or the archived data stream.

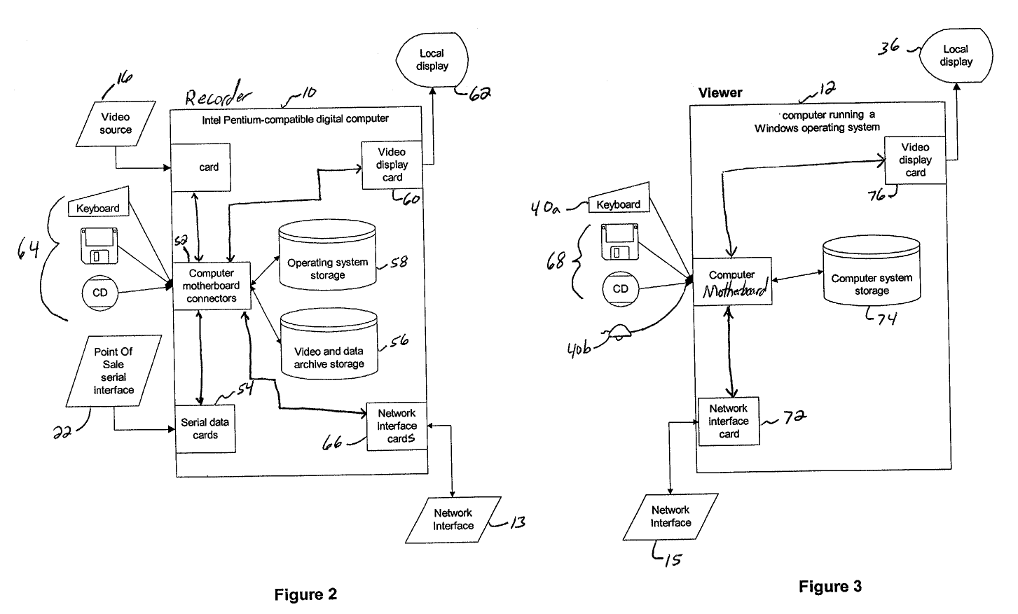

The site terminal 10 in the preferred embodiment is a configured as a general purpose digital processor which executes the processor programs 17, 18, 21 and 25 as applications; and provides interface 24. While many different configuration can be used, the preferred embodiment will be a personal computer system with a hardware configuration as illustrated in FIG. 2. The recorder 10 comprises a pentium compatible digital computer using conventional elements including a computer motherboard 52 having a pentium or higher capability processor. The motherboard 52 is coupled through its backplane to nonvolatile storage or memory including operating system storage 58 and video and data archive storage 56, preferably implemented as separate hard disks. The operating system and application programs of the recorder 10 are stored on the disk 58 and the data and video to be archived are stored on the disk 56. The disk 56 is much larger in capacity than the disk 58 and is sized to store at least one month of video data. Preferably, the disk 56 is 30 gigabytes or more and, optionally, may be duplicated in backup disk which stores the identical data and video information. The recorder 10 includes a number of specialized peripheral cards which are controlled by the motherboard signals through the bus structure. One or more video card(s) 50 are used to receive analog video signals and digitize them and one or more serial data card(s) are coupled to the data ports of the recorder 10 to handle asynchronous data in RS-232 format. The recorder 10 also has one or more network interface card(s) 66 which connects it to the network link 14. The network card(s) 66 could by a dial up modem card or a broadband modem or other high capacity card depending on the type of link contemplated. Preferably, the recorder 10 has both a broadband and narrowband network card 66 to be able to communicate with viewer terminals 12 having either type of connection. The recorder 10 may have other typical peripherals such as input devices 64 and controllers for their data including a keyboard, floppy disk drive, or CD and a video display card 60 and local video dipole 62. Moreover, while many operating systems can be used for the site terminal 10, for purposes of illustration, the preferred embodiment will be described as operating in a LINUX operating environment under the control of a modified kernel.

The remote terminal 12 in FIG. 1 comprises the interface 28 and a view control program 37. The view control program includes a graphical user interface (GUI) 34 on which a user enters commands 40 to view the information stream desired. When the information stream requested from the site terminal is transferred over the communications link 14, the view control program uses either a video interface 34 or a data interface 38 for viewing it on a video display 38.

The remote terminal 12 in the preferred embodiment is a configured as a general purpose digital computer which executes the view control program 32 and interface 28. While many different configuration can be used, a personal computer with a hardware configuration as illustrated in FIG. 3 is preferred. The viewer terminal 12 comprises a digital computer using conventional elements including a computer motherboard 70 having a processor capable of running a 32-bit windows operating system. The motherboard 70 is coupled through its backplane to nonvolatile storage or memory including computer system storage 74, preferably implemented as a hard disk. The operating system and view control program are stored in the disk 74. The viewer terminal 12 includes a number of specialized peripheral cards which are controlled by the motherboard signals through the bus structure. The remote 12 has a network interface card 72 which connects it to the network link 14. The network card 72 can be a dial up modem card or a broadband modem or other high capacity card depending on the type of link contemplated. The remote 12 also includes other typical peripherals such as input devices 68 and controllers for their data including a floppy disk drive, or CD. Preferably, the user inputs 40 are received form input devices such a keyboard 40a or a pointing device 40b, such as a mouse, track ball or the like. Additionally, the remote 12 includes a video display card 76 and local video display 36 to provide the graphics displays form the operating system and view control program, and to provide the displays of the video and data information received from the recorder 10. Moreover, while many operating systems can be used for the remote terminal 12, for purposes of illustration, the preferred embodiment will be described as operating in a windows operating environment as a 32 bit windows application program.

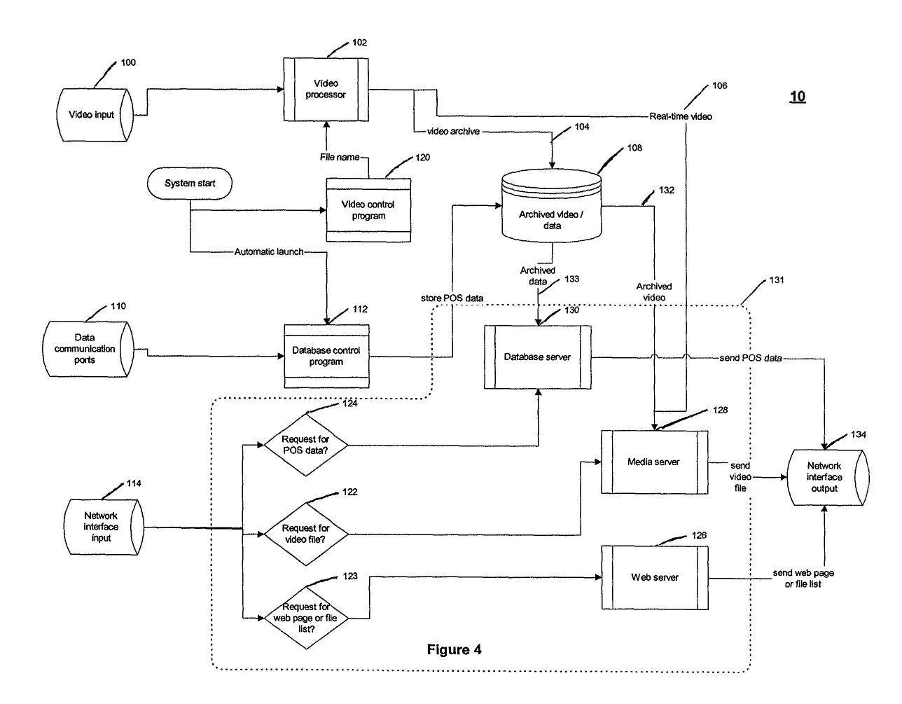

A more detailed system process diagram of the digital recorder 10 will now be described by reference to FIG. 4. The video information signal from the video source is digitized by the video input card 100. In the preferred embodiment, the input card 100 digitizes a quad multiplexer output into a digital stream. The digitized video information signal is then processed by a video processor 102. The video processor 102 basically does two types of processing on the digitized video information signal. Initially, it compresses the video information signal so that it can be more readily stored in the digital archive, represented as the archive disk 108. The video information signal is also compressed so that it can be transmitted at a lower bandwidth over the communications link. Further, the input video processor 102 packetizes the video information into a format compatible with the packet switched communications link which is used. In the preferred embodiment the illustrated communication link is either high speed or very high speed internet access so that the format is that compatible with digital streaming. Preferably, the input video processor 102 is Real Producer which is a commercially available video compression and packetizing program for video storage and streaming. Other video processing programs which can compress and packetize video signals for storage and streaming over the internet may be used. For example, programs which compress and packetize video information in the JPEG format are particularly useful in this regard.

The video processor 102 is controlled by part of the system program in blocks 118 and 120 to record the processed video information signal onto the archive disk 108 in segmented files. Block 108 periodically interrogates the system real time clock 116 to determine the start of each hour. When the system clock 116 indicates it is the start of the hour, block 120 commands the video processor 102 to record the input video signal in memory for the next hour. The name allocated to the video information file recorded in this manner by block 120 is a time stamp of when the record begins including its day:hour:min information. The new file name is also added to the list that a media server 128 can legally access by block 120.

This process advantageously segments the video archive into essentially one hour pieces that are easily transferred and then manipulated at the viewing terminal. Typically, these segments are about 4 Megabytes in length so that they can be transferred for remote viewing without undue delays. One hour segmentation is preferred because that is about the amount of video information that a viewer would typically want to review and manipulate at one time, but it is evident that a finer or coarser segmentation can be easily defined.

Optionally, the archive disk 108 is also coupled to a data processor 112 in the form or a data base loading program. The data processor 112 receives data input from the serial ports of the digital recorder, usually in RS-232 format, and stores this data in a predetermined section of the archive disk 108. Preferably, this is implemented and accomplished by activating a LINUX application program CAT, short for concatenate, during the launch of the system. CAT reads the asynchronous serial data from the named (source) data ports, and builds a data base from that data on the predetermined section (destination) of the archive disk 108. Normally, if this material is point of sale data, it usually has an internal time stamp of when the transaction took place. For that data which is not internally time stamped, the data processor 112 may also read the system clock 116 and store a date stamp with each data event. Because the data archive is not as large as the video archive, it generally need not be segmented. However, for those lengthy data archives which may not be easily transmitted to or manipulated at the viewing terminal, the data archive may optionally be segmented as was described for the video archive.

For transfer of the real time video information, the archived video information, or the archived data, the system includes a plurality of servers, namely a html or web server 126, a media server 128, and a data base server 130. Each server is allocated particular information which it can transfer over the internet. For example, the media server 128 is assigned and has legal access to video information from the video archive disk 108 on line 132 and the real time video information from video processor 102 on line 106. Preferably, the media server is Real Server a commercially available program which can stream video information to users in a server context. The data base server 130 is assigned and has legal access to the data archive of the archive disk 108. Preferably, the data server is MY SQL Server a commercially available program which can transfer data to users in a server context. The web server 126 is assigned and has legal access to the video file names of the archive disk 108. Preferably, the web server is Apache Server a commercially available program which can transfer html formatted information to users in a server context. Preferably, these individual servers are all specially adapted to serve the format of information which they transmit to users, but it evident that one multipurpose server could be used.

Requests from users come in over the internet by way of network interface 114 to the servers 126, 128 and 130. The servers find the requested information and serve it tot he users via the network interface output 134. The network input 114 and output 134 could be either the high speed connection of the modem or the very high speed connection of the network card (DSL or cable modem) depending upon what type of connection the user makes to the internet. As is the general case with servers, the type of user connection will determine the type of transmission connection for the server. In operation requests for information come into the servers through the network interface 114. When a user requests real time video information, the media server 128 through the web server 126 receives the request and serves real time video information from line 106 to the user's address through network interface output 134. Similarly, when a user requests a specific archived video information file in block 122, the media server 128 through the web server 126 receives the request, retrieves the desired video file from archive disk 108, and serves the archived video information from line 132 to the user's address through the network interface output 134. Alternatively, when a user requests the data information file in block 124, the data server 130 receives the request, retrieves the desired data file from archive disk 108, and serves the archived data information from line 136 to the user's address through the network interface output 134. A request for the file list that has been recorded for a particular day is sensed in block and handled by the web server 126. the web server 126 retrieves the video file list for a particular day and serves the information to the user's address through the network interface 132.

The application of servers to the transfer of the video and data information of the surveillance system provides a system which is robust in the data transfer to a remote viewer and can be accessed easily. The server technology allows access to the information for remote viewing anywhere an internet connection can be made, and with a relatively low bandwidth (dial up modem) connection to large bandwidth (broadband) connection. Further, the server technology allows for the system to be multi-user and multiple access. More than one user can view the archived video information, the real time video information or the archived data of a particular site or store location at the same time or even from different remote sites.

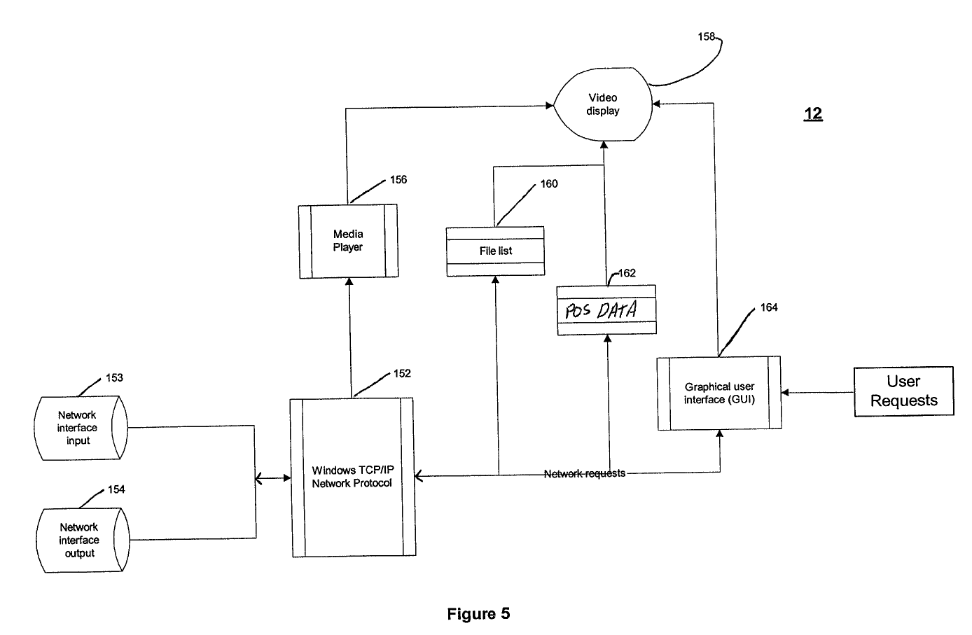

FIG. 5 illustrates a detailed process diagram for the preferred implementation of the viewer terminal 12. User requests for information to be provided from the recorder 10 are made by interacting with the GUI 164. The user makes selections which are guided and assisted by the friendly graphical displays of the GUI 164. The user displays of GUI 164, as will be more fully detailed hereinafter, appear as widow application graphics on the desktop on the local video display 158. The selections of the user may be to view the archived video information, view the associated archived data information or to view the real time video information.

These user selections are transformed into network requests by the view control program using internet protocols and control codes established for the particular request. Such network requests are then transferred to the windows TCP/IP communications routine 152 of the operating system where they are sent out over the internet via network interface output 154 to the site terminal 10 addressed. The site terminal 10 responds to the request and sends the required information over the internet connection to the network interface input 153 where it received by the TCP/IP communications routine 152. Depending upon the type of information and the returning protocol, the TCP/IP communications routine 152 will route the information to one of three display interfaces 156, 160 or 162.

The real time video information and archived video information are routed to a media player 156 which decompresses and depacketizes the information and converts into a video signal which can be viewed on video display 158. Preferably, the media player 156 chosen is a commercially available program Real Player which is compatible with the compression algorithm of the site terminal 10. The video signal from the media player 156 is combined with the video signal from the GUI 164 by the view control program to provide a combined window for viewing the information and making additional choices. The file list and web site information are routed to a file list interface 160 which converts it into a video signal which can be viewed on video display 158. The video signal from the interface 158 is combined with the video signal from the GUI 164 by the view control program to provide a combined window for viewing the information and making additional choices. The data information are routed to an POS data interface 162 which converts it into a video signal which can be viewed on video display 158. The video signal from the media player 156 is combined with the video signal from the GUI 164 by the view control program to provide a combined window for viewing the information and making additional choices.

In operation, for a request to view a list of archived video files for a particular date, the request will be to the web server 126 so the format will be conventional http format addressed to port 80. The information included will be the IP address of the web server 126, a password for the server and an identification of the user. The information will also include the identifying parameters of the information wanted, i.e., the date of the list and the extent of the list wanted on that day. The user makes a similar request to view the web page of the recorder 10. The request uses the identical protocol, IP address, and user identification. The identifying information is provided as the name of the web page instead of the file list.

For a user request to view a video file, a different protocol and port address are used for the network request. The format of the message is preferably in Real Player Media Protocol (RPMP) and the port address is 554, the designated port address under TCP/IP of the real media server. Similar to the other network requests, the IP address of the media server 128, a password for the server and an identification of the user will be included. The real server 128 will respond to a number of different control commands in the request. For a network request for real time video information, the request includes the control code to stream live video from the output of the processor 102. For a network request for archived video information, the request includes the control code to stream stored video from the output of digital archive 108 and the file name of the video to be streamed.

For a user request to view a data file, a different protocol and port address are used for the network request. The format of the message is preferably in the protocol of the data base server 130 and the port address that designated under TCP/IP for the data base server 130. Similar to the other network requests, the IP address of the data base server 130, a password for the server and an identification of the user will be included. The base server 130 will respond to a number of different control commands in the request. For a network request for real time data information, the request includes the control code to transport data form the from the output of the processor 112. For a network request for archived data information, the request includes the control code to transport stored data from the output of digital archive 108 and the file name of the data to be transported.

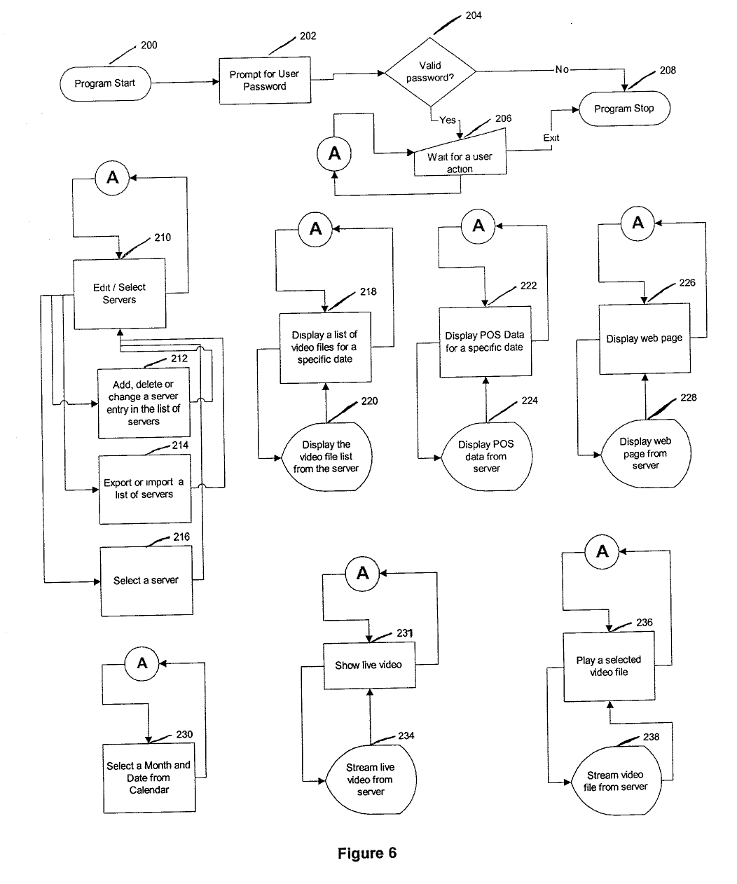

With attention now directed to FIGS. 6-12, the operation of the graphical user interface 164 and the displays generated for the viewer will now be described in more detail. The graphical user interface 164 displays selection widows with choice icons and symbols in the windows operating environment which prompt the user to give responses and commands which regulate the view control program and as a consequence surveillance system.

FIG. 6 is a process diagram of the GUI 164 illustrating the selections available to the user. When a user desires to view either the real time video stream, the archived video stream, or the archived data stream, he will select the view control program from other applications programs stored on the remote terminal 12 and select run from the widows operations list under the start icon on the desk top display. The windows operating environment will load the view control program and begin execution of it instructions in block 200. The first operation of the program is prompt for a password in block 202 and, upon validation in Block 204, wait for a user selection in block 206. If a valid password is not given, the program will exit back to the desktop in block 208.

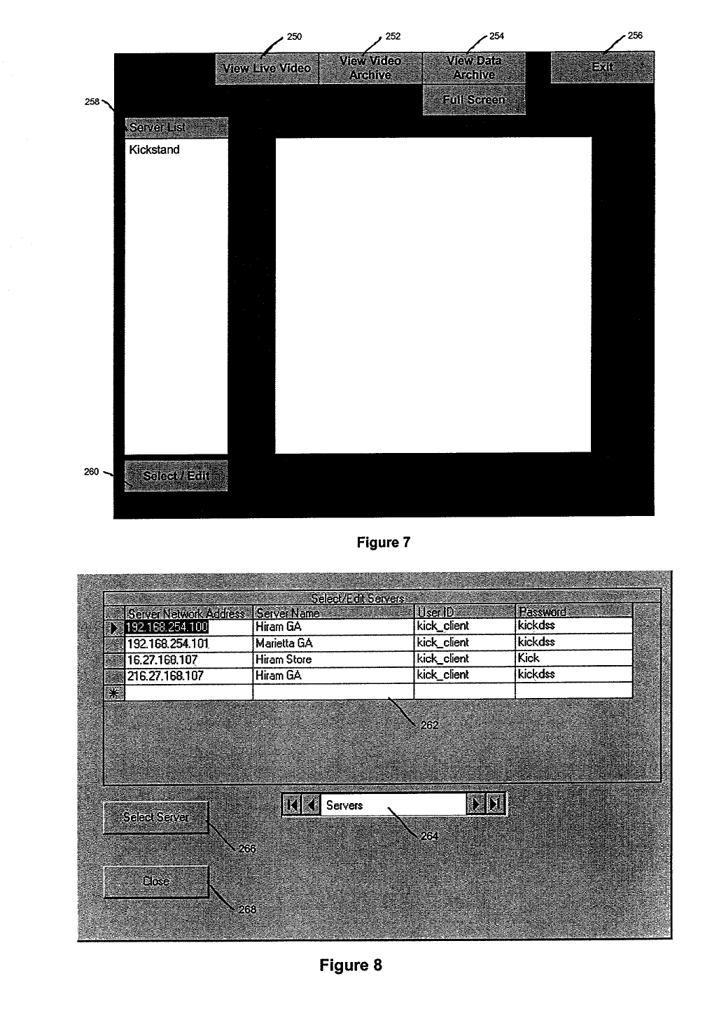

The GUI 164 when entering block 206 will display an initial window on the display 158 depicting the valid selections for the user. The initial window illustrated in FIG. 7 includes a selection bar with four selection buttons including a view live video button 250, a view archived video button 252, a view archived data button 254 and an exit button 256. Selection of the first button 250 with a pointer (mouse click) causes the view control program to produce the live video stream for display in blocks 232 and 234, while selection of the second button 252 causes the view control program to display the archived video stream in blocks 236 and 238. Selection of the third button 254 causes the view control program to produce the archived data stream for display in blocks 222 and 224, while selection of the fourth button 256 causes the view control program to return to the desk top of the windows operating environment in block 208.

Optionally, the view control program has the capability of selecting a video stream or data from more than one recorder site, such as when a business has a chain of stores Each separate site is embodied as a separate web server or web site with its own unique address designation. When this option is provided in the view control program, in the initial window in FIG. 7, a server or site list 258 is displayed on the left portion of the screen. One of the sites on the list can be selected by highlighting it with a click of the pointing device. The buttons 250, 252, 254 are then associated to the chosen recorder 10 and apply to the information from that site.

Optionally, the user when viewing the server list 258 has the ability to edit (add, delete, or change) a server from the list. To edit the list 258, a select/edit button 260 is chosen by a double click of the pointer device. This will cause the GUI 164 in block 210 to display a server list window as seen in FIG. 8 as an overlay on the initial window. The sever list window provides a display box 262 which lists all of the information for the recorders 10 presently on the list. The box 262 also provides empty lines where a user can type in the name of a recorder to be added. Preferably, the site name (or street address) and the internet protocol (IP) address (or the Universal Resource Locator (URL)) address of the server is provided for each entry. Also, the password for the server and the user ID is provided in each entry. These functions are performed in block 212 through interactions of the program and the user in block 212. For entering information on more than one server at once, for example the initial list, a button 264 is selected allowing the entire list to be imported from or exported to other storage areas, computers, or communications links. This function is performed in block 214. While using this window display, one of the servers in the list may be selected for viewing by scrolling to the desired entry to highlight it and the clicking on a select server button 266 in block 216. The selection of a server or the selecting of a close button 268 will cause the GUI 164 to redisplay the initial window in FIG. 7.

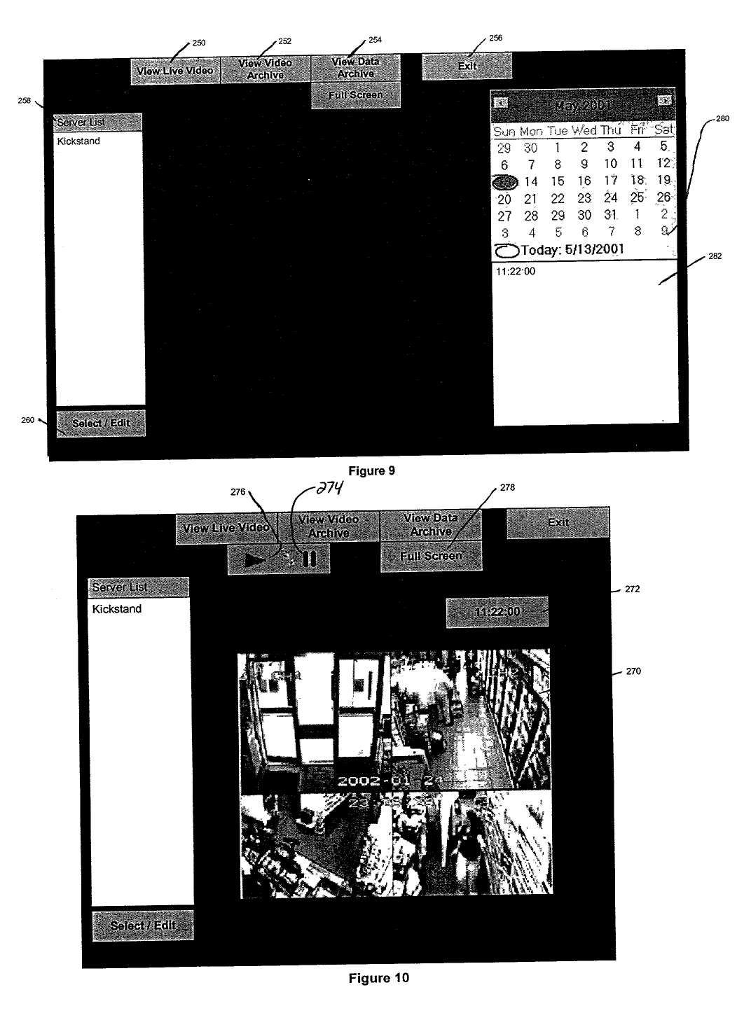

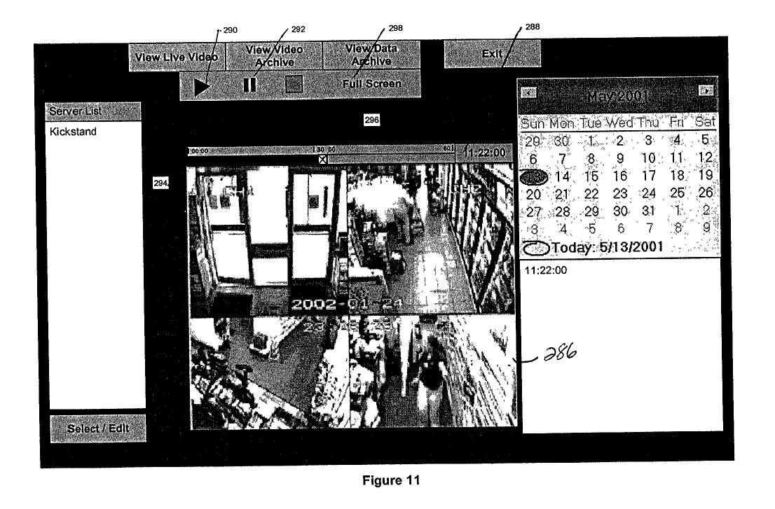

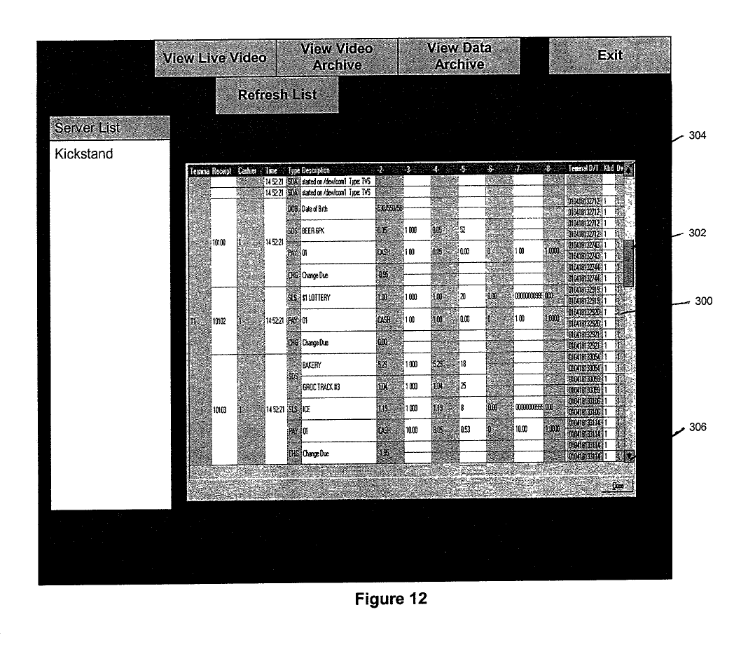

Once a site has been selected and one of the view selection buttons enabled, the view control program will display one of the windows shown in FIGS. 9-12. The window in FIG. 10 is used for the display of the real time video stream, the widows in FIGS. 9 and 11 are used for the display of the archived video stream and the window in FIG. 12 is used for display of the archived data.

When the view control program is displaying the real time video stream, the window shown in FIG. 10 provides a live view screen 270 where the real time video stream is displayed. A time counter 272 indicating the elapsed time from the start of the display of the video stream is provided in the upper right hand corner of the window. Further provided are a pause icon 274 which can be selected to stop the stream of video and display a selected time in stop motion. While the real time stream is paused, the time counter 272 will also stop and indicate the time of the video segment being paused from the start of the session. A resume icon 276 is selected to start the real time stream of video for display on the live view screen. The time counter 272 will resume indicating the time elapsed form the restart of the real time video stream. A full screen button 278 can be selected at any time to expand the display of the real time video stream in the live view screen to fill the entire window. The widow also provides for a return to the smaller live screen display by means of a right mouse click or escape key press.

When the view control program is displaying the archived video stream, the window shown in FIG. 9 provides a archived view screen where the archived video stream is displayed. Initially, the screen is blank because an archived file has to be chosen for display. The selection of the archived file which will be displayed is accomplished with a calendar icon 280 which allows the highlighting of any day (for example January 25) in a predetermined period of time. In the illustrated embodiment this is thirty days or the normal time a remote site would archive video files. The user will highlight a date on the calendar in block 230 causing the view control program to send a request to the selected recorder 10 for the names of any files for that day. The file list which comes back from the recorder 10 is then displayed in a archived file list 282. The list is in order of the times which the video files were stored on the selected date. In the illustrated example, the selected date is Jan. 25, 2001 and the file to be displayed was stored on that date beginning at 11:22 P.M. This function is performed in blocks 218 and 220 of the view control program in FIG. 6.

Once the date and time have been selected, the play icon 290 is selected to cause the file to be displayed on the archived view screen 286 in FIG. 11. A time counter 288 indicating the length of the video file and the elapsed time from the start of the display of the video stream is provided in the upper right hand corner of the window. Further provided are a pause icon 292 which can be selected to stop the stream of video and display a selected time in stop motion. While the archived stream is paused, the time counter 288 will stop also and indicate the time of the video segment being paused from the start of the file. The play icon 290 is selected to start the archived stream of video for display on the archived view screen. The time counter 288 will resume indicating the time elapsed form the start of the archived video stream. As a further option, a scroll bar 294 segmented into equal increments of an hour is displayed on top of the archived video screen. By dragging the slider button 296 with the mouse, it can be rapidly positioned at any place along the hour length scroll bar. The archived video file will then begin to play from the selected time on the scroll bar. This essentially works similar to the fast forward or fast reverse function for a VCR where any particular time in a video file can be rapidly selected and played. A full screen button 298 can be selected at any time to expand the display of the archived video stream in the archived view screen to fill the entire window. The widow also provides for a return to the smaller archived screen display by means of a right mouse click or escape key press.

When the view control program is displaying the archived data stream, the window shown in FIG. 12 provides a data view screen 300 where the archived data stream is displayed. The first page in the archived data is displayed initially. The entire data file or any part of the data file can be quickly viewed by sliding the slider button 302 of a scroll bar form top to bottom. Smaller increments of scrolling are also available by up arrow and down arrow buttons 304 and 306 on the scroll bar.

While the invention has been described in connection with the preferred embodiments, this specification is not intended to limit the scope of the invention to the particular forms or methods set forth herein. But, to the contrary, it is intended to cover any such alternatives, modifications, and equivalents as may be included within the spirit and scope of the invention as defined by the appended claims.

What is claimed is:

1. A video surveillance system comprising:
a surveillance terminal located at a field site;
a viewing terminal located remotely from the field site; and
a communications link connecting said viewing terminal to said surveillance terminal;
said surveillance terminal including an input video processor, a digital memory connected to said input video processor, and an output processor connected to said input video processor and said digital memory;
said input video processor adapted to receive video information from a video source, archive said video information to said digital memory and to provide real time video information to said output processor;
said output processor adapted to retrieve said archived video information from said digital memory or to receive said real time video information from said input processor and to communicate said video information over the communications link;
said viewing terminal including a view control processor, a video display processor and a video display;
said view control processor adapted to receive a user command which selects either the archived video information or the real time video information and communicates said user command to said surveillance terminal over said communications link;
said video processor adapted to receive said video information from said communications link and display it on said video display; and
wherein said output video processor of said surveillance terminal is responsive to said user command to selectively communicate either said archived video information or said real time video information to said viewer terminal over said communications link.

2. The video surveillance system as set forth in claim 1 which further comprises:
an input data processor, connected to said digital memory and to said output processor, adapted to receive data information from a data source, archive said data information to said digital memory and to provide real time data information to said output processor; and
said output processor adapted to retrieve said archived data information from said digital memory or to receive said real time data information from said input data processor and to communicate data information over the communications link;

3. The video surveillance system as set forth in claim 1 which further comprises:
said view control processor further adapted to receive a user command which selects either the archived data information or the real time data information and communicates said user command to said surveillance terminal over said communications link;
said video display processor further adapted to receive said data information from said communications link and display it on said video display; and
wherein said output processor of said surveillance terminal is responsive to said user command to selectively communicate either said archived data information or said real time data information to said viewer terminal over said communications link.

4. The video surveillance system as set forth in claim 1 wherein said digital memory includes:
a hard disk drive.

5. The video surveillance system as set forth in claim 4 wherein said digital memory further includes:
a back up hard disk drive.

6. The video surveillance system as set forth in claim 1 wherein:
said digital memory includes random access memory; and
said input processor segments said archived video data into files of a predetermined length of time.

7. The video surveillance system as set forth in claim 6 wherein:
said digital random access memory is a hard disk drive; and
said input processor names each archived video file as the starting time of recording the file.

8. The video surveillance system as set forth in claim 1 wherein:
said communications link includes an internet connection with a server presence at the surveillance terminal and a user interface at the viewing terminal.

9. The video surveillance system as set forth in claim 1 wherein:
said video input processor compresses said video information before it is archived.

10. The video surveillance system as set forth in claim 1 wherein:
said video input processor compresses said real time video information before it is transferred to said output processor.

11. A video surveillance recorder having a nonvolatile memory comprising:
An input video processor for receiving and processing a video signal from a video source to provide a processed video signal;
means for recording said processed video signal in the nonvolatile memory in file segments of a predetermined length, wherein each file segment is associated with a file identifier related to the time of recording said file segment; and
means for retrieving a file segment from said nonvolatile memory utilizing said file identifiers based on a user request to view a file segment recorded at a selected time.

12. A video surveillance recorder as set forth in claim 11 further comprising:
An input data processor for receiving and processing a data signal from a data source to provide a processed data signal;
means for recording said processed data signal in the nonvolatile memory as a series of events, wherein each event is associated with an event identifier related to the time of occurrence of the event; and
means for retrieving an event from said nonvolatile memory utilizing said event identifiers based on a user request to view data from an event occurring at a selected time.

13. A video surveillance recorder as set forth in claim 12 wherein:
said event data is associated with the content of the video files and the selected time of viewing is the same time.

14. A video surveillance recorder as set forth in claim 11 further comprising:
means for converting said processed video signal back into a video signal.

15. A video surveillance recorder as set forth in claim 12 further comprising:
means for converting said processed data signal back into a data signal.

16. A video surveillance recorder as set forth in claim 11 wherein said video input processing means further comprises:
means for compressing said video signal.

17. A video surveillance recorder as set forth in claim 11 further comprising:
means for communicating said retrieved file segment to a remote viewing terminal.

18. A video surveillance recorder as set forth in claim 17 wherein said means for communicating further comprises:
means for converting said retrieved file segment into TCP/IP format.

19. A video surveillance recorder as set forth in claim 12 further comprising:
means for communicating said retrieved event data to a remote viewing terminal.

18. A video surveillance recorder as set forth in claim 17 wherein said means for communicating further comprises:
means for converting said retrieved event data into TCP/IP format.
